(19) United States
(12) Patent Application Publication
(10) Pub. No.: US 2002/0128961 A1
(43) Pub. Date: Sep. 12, 2002

(54) Method for earning equity while renting

(76) Inventor: Gregory Dwight, Scottsdale, AZ (US)

Correspondence Address: WEISS & MOY PC, 4204 NORTH BROWN AVENUE, SCOTTSDALE, AZ, 85251, US

(21) Appl. No.: 09/802,562

(22) Filed: Mar. 12, 2001

(51) Int. Cl. G06F 17/60

(52) U.S. Cl. 705/38; 705/1

(57) ABSTRACT

A method which allows a tenant to earn equity while renting wherein the equity earned may be used for any costs associated with the purchase of real estate. The method comprises the steps of: signing a lease agreement between a tenant and a property management group for a rented residence; applying for a mortgage loan by the tenant with a mortgage company associated with the property management group; purchasing the real estate by the tenant through a real estate company associated with the property management group; splitting a commission on sale of the real estate between the real estate company, the property management group, and the tenant.

### BACKGROUND OF THE INVENTION

1. Field of the Invention

This invention relates to home ownership and, more specifically, to a method which allows a person who is renting to earn equity during the term of the lease. The earned equity may be used for any costs associated with the purchase of a home.

2. Description of the Prior Art

For the last several years, the housing industry has been booming. More and more people are buying homes for the first time. Even people who already own a home are buying and moving into larger and more expensive homes. Even with a booming economy, many people are still unable to purchase a home. Most of these people end up renting an apartment, condominium, house or the like.

The main reason most people rent is that they feel that they do not have a sufficient amount of money to place a down payment on a house. Many people think that in order to qualify for a loan to purchase a house, they will need to have at least twenty percent of the purchase price of the home to use for a down payment.

As a general rule, this is not true, and a person may qualify for a home loan with a much smaller down payment. However, some people still do not have a sufficient amount of money for the smaller down payment. The problem is further compounded for many people who rent. Many people who rent find it difficult to save additional money for a larger down payment since a majority of their earnings are used for their monthly rental payment.

Therefore, a need existed to provide a method for earning equity while paying rent for a place to live. The earned equity could be used for any costs associated with the purchase of real estate. The earned equity could be used for the down payment for the home purchase, closing costs associated with the purchase, interest rate buy down, or any other cost associated with the purchase of the home.

### SUMMARY OF THE INVENTION

In accordance with one embodiment of the present invention, it is an object of the present invention to provide a method for earning equity while paying rent for a place to live.

It is another object of the present invention to provide a method for earning equity while paying rent for a place to live wherein the earned equity may be used for any costs associated with the purchase of real estate.

It is another object of the present invention to provide a method for earning equity while paying rent for a place to live wherein the earned equity may be used for the down payment for a home purchase, closing costs associated with the purchase, interest rate buy down, or any other associated costs.

### BRIEF DESCRIPTION OF THE PREFERRED EMBODIMENTS

In accordance with one embodiment of the present invention a method for earning equity while renting is disclosed. The equity earned may be used for any costs associated with the purchase of real estate. The method comprises the steps of: forming a relationship between a mortgage company, a property management group, and a real estate company; signing a lease agreement between a tenant and the property management group for a rented residence; applying for a mortgage loan by the tenant with the mortgage company; purchasing a home by the tenant through the real estate company; splitting a commission on sale of the home between the real estate company and the property management group; and gifting a portion of the commission received by the property management group to the tenant.

In accordance with another embodiment of the present invention a method for earning equity while renting is disclosed. The equity earned may be used for any costs associated with the purchase of real estate. The method comprises the steps of: signing a lease agreement between a tenant and a property management group for a rented residence; applying for a mortgage loan by the tenant with a mortgage company associated with the property management group; purchasing the real estate by the tenant through a real estate company associated with the property management group; splitting a commission on sale of the real estate between the real estate company, the property management group, and the tenant.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

FIG. 1A is a simplified functional block diagram showing one embodiment of the relationship between the parties.

FIG. 1B is a simplified functional block diagram showing another embodiment of the relationship between the parties.

FIG. 2 is a flowchart depicting the method of the present invention.

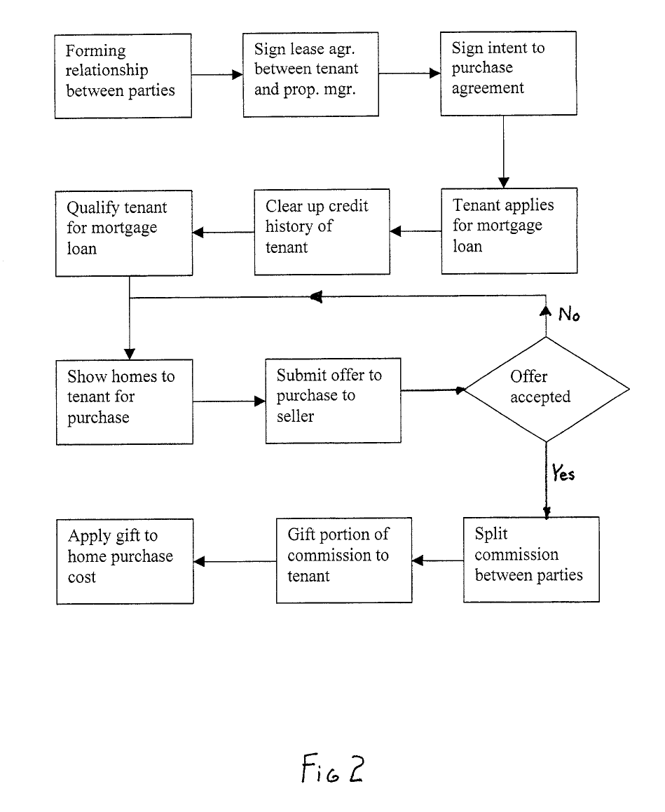

### DETAILED DESCRIPTION OF THE PREFERRED EMBODIMENT

Referring to the Figures a method for earning equity while paying rent for a place to live will be disclosed. By forming a relationship between a property management group, a real estate company, and a mortgage company, an individual tenant will be able to earn equity while paying rent for a place to live. The earned equity may be used toward the down payment for a home purchase, closing costs associated with the purchase, interest rate buy down, or any other costs associated with the purchase of a home.

A person who is looking for a temporary place to live will generally rent an apartment, condominium or house. When renting property, the person signs a lease with a property manager of the rented abode. The length of the lease may vary. In general, most leases will have a term from six to twelve months. Under one embodiment of the present invention, the longer the term of the lease, the more equity the tenant will earn which may be used toward any costs associated with the purchase of a home. When the tenant signs the lease, the tenant will also sign an intent to purchase agreement. The intent to purchase agreement is an agreement which states that the tenant has the intention of purchasing a house and will try to reasonably do so.

Once the tenant signs the intent to purchase agreement, the tenant will fill out a mortgage application with the associated mortgage company. The mortgage company will obtain income documentation from the tenant and review the tenant's credit history. During the term of the lease, the mortgage company will try and resolve any credit issues the tenant may have. In other words, the mortgage company will begin the process of trying to clean up the tenant's credit so that the tenant will qualify for a target loan amount which the tenant and mortgage company have determined.

In order for the tenant to fully qualify for the earn equity program, the tenant should remain in the residence for the entire term of the lease. The tenant should further make all rental payments in a timely manner. In accordance with one embodiment of the present invention, if the tenant decides to break the lease agreement, the tenant may still be able to earn equity towards the purchase of a home but only on a prorated basis. If the tenant decides to break the lease, the tenant must still abide with conditions which will be discussed below in order to qualify for the prorated earned equity.

Towards the end of the lease, the tenant will be contacted by a realtor with the associated real estate company (or the tenant may contact the real estate company directly). The tenant will have to use the associated real estate company and the associated mortgage company in order to earn equity that could be used towards any of the costs associated with the purchase of a home.

Once the realtor and the tenant make contact, the two may begin discussions on property location, size and style of the home desired, etc. Once the realtor has the housing criteria that the tenant desires, the realtor will perform a search for all houses currently for sale that match the tenants criteria. The realtor will then show the tenant all property listings that match the criteria.

When the tenant finds a home that the tenant desires to purchase, the tenant will submit an offer on the desired home. The realtor will submit a written offer to the seller. If the seller agrees to the submitted offer, the commission from the sold home will be divided so as to give a portion of the commission to the tenant. The tenant can then use this money towards any costs associated with the purchase of the home.

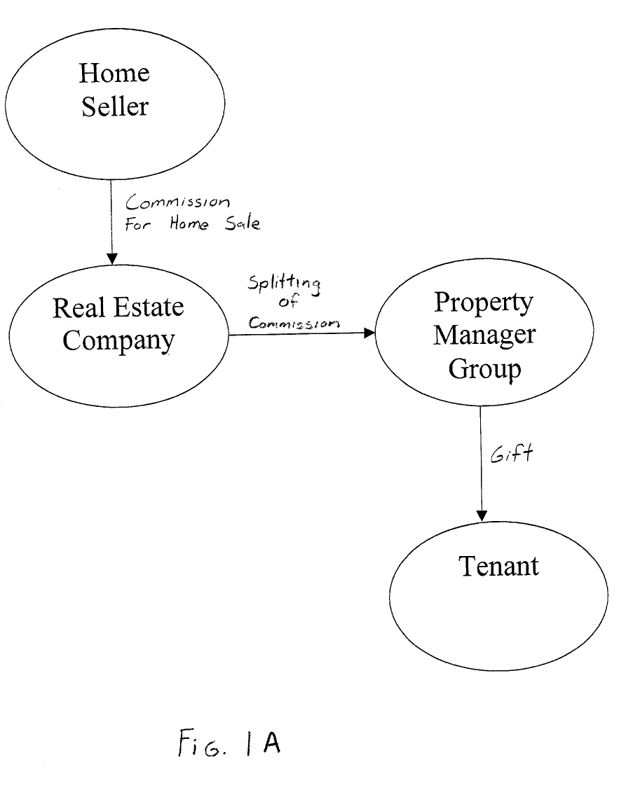

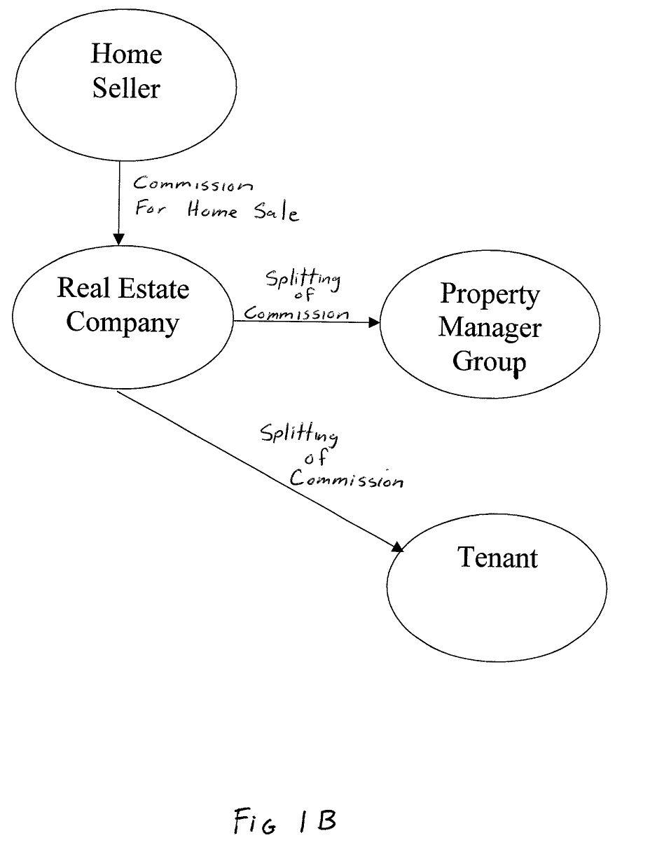

In real estate purchase agreements, a portion of the sales price is generally set aside as a commission. In accordance with one embodiment of the present method as shown in FIG. 1A, the commission is divided accordingly. When the real estate sales contract is drafted, the realtor will draft the agreement so that the property manager is listed as the tenant's real estate agent (Buyer's Agent). The real estate agent and the property manager will then divide the commission. A portion of the property manager's commission will then be given as a gift from the property manager to the tenant. The tenant may then use this money toward the down payment for the home purchase, closing costs, interest rate buy down, or any other cost associated with the purchase of the home.

As an example, let's say that the commission for the sale of a home is seven (7) percent of the home sale price. Generally, the contract is written so that the realtor and the property manager equally split the commission. Thus, the realtor and the property manager would each receive three and a half (3.5) percent of the home sale price. The property manager will then give as a gift a certain percentage of his/her commission. The amount of the gift will vary and could be based on such factors as the length of the lease and the amount of the rent. In general, the property manager would give as a gift fifty (50) to seventy five (75) percent of his/her commission. Thus, the tenant could earn 1.75 to 2.45 percent of the sales price of the home to use toward the down payment for the home purchase, closing costs, interest rate buy down, or any other cost associated with the purchase of the home. It should be noted that the above numbers are just an example and should not be seen as to limit the scope of the present invention.

In accordance with another embodiment of the present method as shown in FIG. 1B, the commission is divided accordingly. When the real estate sales contract is drafted, the realtor will draft the agreement so that the real estate company will receive a commission for the sale of the home. The real estate company will then split the commission with both the property management group and the tenant. The tenant may then use this money toward the down payment for the home purchase, closing costs, interest rate buy down, or any other cost associated with the purchase of the home.

As an example, let's say that the commission for the sale of a home is seven (7) percent of the home sale price. The real estate company would keep 42.86 percent of the commission (approximately equal to 3 of the 7). The remainder of the commission, approximately 57.14 percent (4 of the 7) would be split between the tenant and the property management group. The tenant may be given 42.86 percent of the commission (approximately equal to 3 of the 7). The property management group would then receive the remaining 14.29 percent (approximately 1 of the 7). Thus, the tenant could earn 3 percent of the sales price of the home to use toward the down payment for the home purchase, closing costs, interest rate buy down, or any other cost associated with the purchase of the home. It should be noted that the above numbers are just an example and should not be seen as to limit the scope of the present invention.

The above method is advantageous to all the parties involved. The tenant during the time of the lease is able to earn equity which the tenant may then place towards the down payment for the home purchase, closing costs, interest rate buy down, or any other cost associated with the purchase of the home.

The property manager where the tenant rents his/her residence is able to have a huge advantage in attracting new tenants. This is due to the fact that the tenant is able to earn equity towards any costs associated with a home purchase during the term of the lease. The property manager is further able to earn a commission when the tenant purchases a home. The realtor would also benefit since the realtor would have a steady flow of clients. Further, the realtor would be able to attract new listings since the realtor would have hundreds of potential buyers.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for earning equity while renting wherein the earned equity may be used for costs associated with a purchase of a home comprising the steps of:
forming a relationship between a mortgage company, a property management group, and a real estate company;
signing a lease agreement between a tenant and the property management group for a rented residence;
applying for a mortgage loan by the tenant with the mortgage company;
purchasing the home by the tenant through the real estate company;
splitting a commission on sale of the home between the real estate company and the property management group; and
gifting of portion of the commission received by the property management group to the tenant.

2. The method of claim 1 further comprising the step of signing an intent to purchase agreement by the tenant after signing the lease agreement.

3. The method of claim 1 further comprising the step of paying of rental payments by the tenant for the rented residence.

4. The method of claim 1 further comprising the steps of:
paying of rental payments by the tenant for the rented residence; and
remaining in the rented residence during the entire term of the lease.

5. The method of claim 1 wherein the step of applying for a mortgage loan by the tenant with the mortgage company further comprises the steps of:
resolving any credit issues of the tenant during the term of the lease; and
qualifying the tenant for a home mortgage loan.

6. The method of claim 1 further comprising the step of showing homes by the real estate company to the tenant.

7. The method of claim 1 further comprising the step of using the gifted portion of the commission received by the tenant to pay for costs associated with the purchase of the home.

8. The method of claim 7 wherein the costs associated with the purchase of the home are a down payment for the home, closing costs associated with the purchase, and interest rate buy down.

9. A method for earning equity while renting wherein the earned equity may be used for costs associated with a purchase of real estate comprising the steps of:
signing a lease agreement between a tenant and a property management group for a rented residence;
applying for a mortgage loan by the tenant with a mortgage company associated with the property management group;
purchasing the real estate by the tenant through a real estate company associated with the property management group; and
splitting a commission on sale of the real estate between the real estate company, the property management group, and the tenant.

10. The method of claim 9 wherein the step of splitting a commission on sale of the real estate between the real estate company, the property management group, and the tenant further comprises the steps of
splitting the commission on sale of the real estate between the real estate company and the property management group; and
gifting a portion of the commission received by the property management group to the tenant.

11. The method of claim 9 further comprising the step of signing an intent to purchase agreement by the tenant once the lease agreement has been signed.

12. The method of claim 9 further comprising the steps of:
paying of rental payments by the tenant for the rented residence; and
remaining in the rented residence during the term of the lease.

13. The method of claim 9 wherein the step of applying for a mortgage loan by the tenant with the mortgage company further comprises the steps of:
resolving any credit issues of the tenant during the term of the lease; and
qualifying the tenant for a mortgage loan.

14. The method of claim 9 further comprising the step of showing real estate by the real estate company to the tenant.

15. The method of claim 10 wherein the step of splitting of a commission on sale of the home between the real estate company and the property management group further comprises the step of equally splitting the commission of the home sale between the real estate company and the property management group.

16. The method of claim 10 wherein the step of gifting of a portion of the commission received by the property management group to the tenant further comprises the step of gifting of approximately 40 to 80 percent of the commission received by the property management group to the tenant.

17. A method for earning equity while renting wherein the earned equity may be used towards purchasing real estate comprising the steps of:
signing a lease agreement between a tenant and a property management group for a rented residence;
signing an intent to purchase agreement by the tenant once the lease agreement has been signed;
applying for a mortgage loan by the tenant with a mortgage company associated with the property management group;
showing homes by a real estate company associated with the property management group to the tenant that are of interest to the tenant;
purchasing a home by the tenant through the real estate company;
splitting of a commission on sale of the home between the real estate company, the property management group, and the tenant.

18. The method of claim 17 wherein the step of splitting of a commission on sale of the home between the real estate company, the property management group, and the tenant further comprises the steps of:
splitting of the commission on sale of the home between the real estate company and the property management group; and
gifting a portion of the commission received by the property management group to the tenant.

19. The method of claim 17 further comprising the steps of:
paying of rent payments by the tenant for the rented residence; and
remaining in the rented residence during the term of the lease.

20. The method of claim 17 wherein the step of applying for a mortgage loan by the tenant with the mortgage company further comprises the steps of:
resolving any credit issues of the tenant during the term of the lease; and
qualifying the tenant for a home mortgage loan.

21. The method of claim 18 wherein the step of splitting of a commission on sale of the home between the real estate company and the property management group further comprises the step of equally splitting the commission of the home sale between the real estate company and the property management group.

22. The method of claim 18 wherein the step of gifting of a portion of the commission received by the property management group to the tenant further comprises the step of gifting of approximately 40 to 80 percent of the commission received by the property management group to the tenant.
